(19) United States
(12) Patent Application Publication
(10) Pub. No.: US 2005/0129491 A1
(43) Pub. Date: Jun. 16, 2005

(54) Hand cart for lifting and moving round containers

(75) Inventor: Peter T. Smith, Peapack, NJ (US)

Correspondence Address: Richard C. Woodbridge, Esq.;Synnestvedt Lechner & Woodbridge, LLP, P.O. Box 592, Princeton, NJ, 08542-0592, US

(73) Assignee: Cuchipanda, Inc., Peapack, NJ (US)

(21) Appl. No.: 11/008,691

(22) Filed: Dec. 9, 2004

Related U.S. Application Data
(60) Provisional application No. 60/529,188, filed on Dec. 12, 2003.

(51) Int. Cl. B62B 1/00

(52) U.S. Cl. 414/490

(57) ABSTRACT

A hand cart for gripping and transporting heavy or large pots and the like includes articulated jaws for gripping the pot. The jaws each include a front and rear section and are carried on base plates respectively while also supporting an optional bracket for engaging and supporting the rim of the pot during transport. A lever and cable mechanism control the opening and closing of the jaws.

### CROSS REFERENCE TO RELATED APPLICATIONS

This application claims the priority of provisional U.S. application Ser. No. 60/529,188 filed on Dec. 12, 2003 and entitled “HAND CART/TRUCK FOR LIFTING AND MOVING ROUND CONTAINERS OR OBJECTS WITH VERTICAL TO TAPERING SIDES” by Peter T. Smith, the entire contents and substance of which are hereby incorporated in total by reference.

### BACKGROUND OF THE INVENTION

1. Field of the Invention

The invention relates to a hand cart or truck having a pair of jaws adapted for lifting and moving containers or objects having a rim and/or vertical to tapered sidewalls.

2. Description of Related Art

Gardeners and landscapers frequently have to lift heavy pots which have cylindrical or tapered sidewalls and a rim. Such pots are frequently filled with heavy potting soil and plants. They are difficult to grip and pose a lifting hazard to the plant mover.

There are devices known in the art to assist in the lifting of heavy objects. A tool suitable for assisting in the lifting of smaller pots is described in my co-pending application Ser. No. 10/364,576 entitled “A Tool for Gripping Flowerpots and Items of Similar Shape” filed on Feb. 10, 2003. That application describes a tool, preferably used in pairs, that assists in the gripping of the rim of a flowerpot so that it can be manually picked up. While the foregoing invention is useful for picking up relatively small objects, it is not suitable for substantially heavier objects.

Traditionally gardeners and landscapers have used wheelbarrows or even motorized tractors for picking up and moving heavy pots including shrubbery and plants. Unfortunately, wheelbarrows tend to be clumsy and motorized tractor devices are expensive. There appears to be a clear need for a non-motorized, inexpensive device that a gardener or landscaper can use to pick up and move pots that are too heavy for an individual to otherwise lift without assistance.

It was in the context of the foregoing prior art that the present invention arose.

### SUMMARY OF THE INVENTION

Briefly described, the invention comprises a hand cart or truck including articulatable jaws that can pick up a heavy pot having tapered or cylindrical sidewalls and/or a rim. The jaws of the invention comprise a rear section and a front section that can adjust to the sidewall of the pot or container within a reasonable range of diameter. The rear jaw of the pair can swivel or rotate about an axis. The front jaw can also rotate about an axis but is assisted by a gas spring to provide an appropriate amount of tension to return it to the open position. A rim support bracket is carried by the jaws and engages the lower rim of the pot or container in order to help keep it upright and provide an additional point of support. The rim support bracket is selectively removable and adjustable to accommodate the particular pot or circumstances. The opposing jaws are carried on a pair of crossed arms the distal ends of which are connected to a cable and pulley system attached to a lever. Pulling backwards on the lever causes the jaws to close and engage the pot. A ratchet or guide mechanism holds the lever in its withdrawn position until the operator is ready to release it thereby causing the jaws to disengage and the pot to be released. The cart includes a pair of wheels and skids so that the cart can be taken from location to location and, when not in use, can be laid down horizontally resting on its skids.

The invention may be better understood by reference to the following drawings.

### BRIEF DESCRIPTION OF THE DRAWINGS

FIG. 1 is a front perspective view of the preferred embodiment of the invention with the jaws shown in the open position and a pot shown in phantom lines.

FIG. 2 is a front perspective view of the preferred embodiment of the invention shown in FIG. 1 with the jaws shown clamped around a pot illustrated in phantom and, further, wherein the rim support brackets are in position supporting the rim of the pot.

FIG. 3 is a partial side perspective view of the invention illustrating the manner in which the removable rim support brackets are attached to the jaw mechanism.

FIG. 4 is a side perspective view of the invention showing the cart resting on its skid plates with the jaws disengaged.

FIG. 5 is a side perspective view of the invention showing the cart resting on its skid plates and the jaws engaging a pot.

### DETAILED DESCRIPTION OF THE INVENTION

During the course of this description like numbers will be used to identify like elements according to the different views that illustrate the invention.

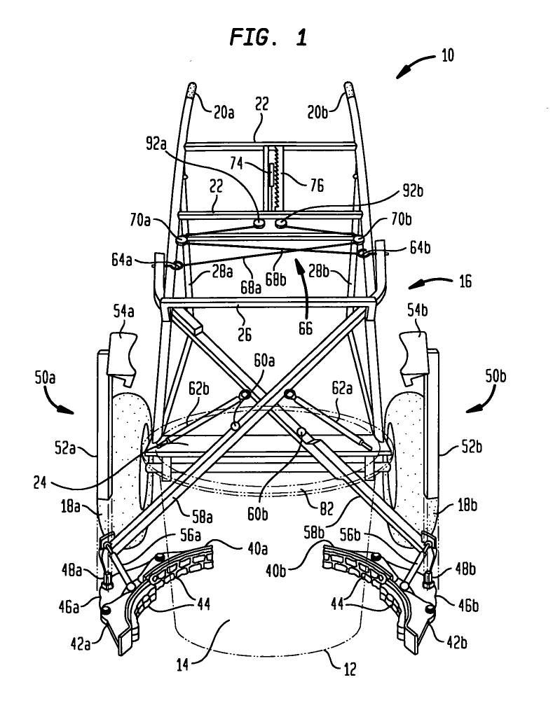

The preferred embodiment 10 of the invention is illustrated in FIGS. 1-5. FIG. 1 is a front perspective view of the invention 10 as it is about to grip a pot 12 shown in phantom. A typical pot 12 includes tapered sidewalls 10 and a rim 82. While tapered sidewalls 14 are illustrated, it will be appreciated by those of ordinary skill in the art that the pot 12 could also have vertical, that is to say cylindrical, sidewalls 14. It is very common for pots 12, such as shown in FIG. 1, to be filled with heavy, moist potting soil and a plant. Such pots 12 can be very heavy and easily weigh up to 150 pounds.

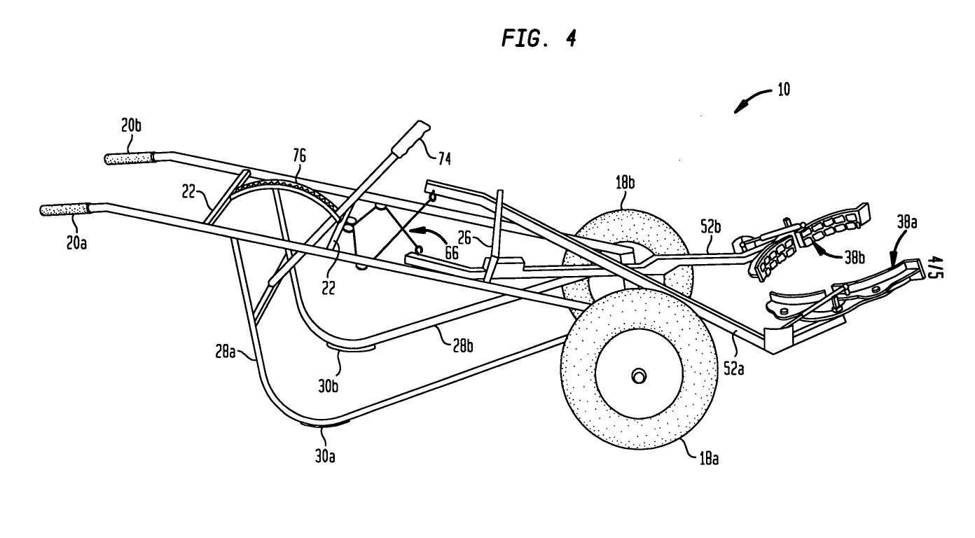

The hand cart 10 includes a frame 16 which supports the elements of the invention. Frame 16 supports right and left wheels 18a and 18b, respectively and further includes right and left handle sections 20a and 20b. A pair of cross pieces 22 brace the frame 16 at the top, while a cradle arm 26 provides support in the center and a base plate 24 provides support at the bottom. A pair of right and left legs 28a and 28b, bent at right angles in the center, are attached to the handle sections 20a and 20b, respectively of the frame 16. Right and left skid plates 30a and 30b are attached respectively near the elbow bend sections of the right and left legs 28a and 28b and provide support to the invention 10 when not in use as shown in FIG. 4. Wheel axle 32 is attached to and mounted on base plate 24 and provides support for wheels 18a and 18b.

The primary purpose of the frame 16 and wheels 18a and 18b is to support the gripping system 36. Gripping system 36 includes right and left jaws 38a and 38b, respectively. The right and left jaws 38a and 38b each include right and left rear jaws 40a and 40b and right and left front jaws 42a and 42b. A jaw carrier base plate 46a supports the right rear jaw 40a and right front jaw 42a. Rear jaw 40a is preferably attached by a pin or bolt to the jaw carrier base plate 46a and the right front jaw 42a is also attached in a similar manner to the jaw carrier base 46a. Likewise, the left rear jaw 40b is attached to the jaw carrier base 46b in a pivotal manner with a bolt or rivet and the front jaw 42b is attached is jaw carrier plate 46b with a bolt or rivet. In this manner jaws 40a, 40b, 42a and 42b can rotate as they grab the sidewalls 14 of a pot 12. A gas spring 46a is attached is the front jaw 42a at one end and at the other end to arm 58a. Similarly, gas spring 56b is attached to front jaw 42b and to arm 58b. Arms 56a and 56b cross each other approximately mid-frame and are attached by pins or bolts 60a and 60b to base plate 24 so that they can rotate or pivot about those points. A pair of extension springs 62a and 62b are attached respectively to arms 58a and 58b at one end and at the other end to base plate 24. The purpose of extension springs 62a and 62b is to normally bias the jaws 38a and 38b in a normally open position as shown FIGS. 1 and 4. The distal end of arms 58a and 58b from the jaws 38a and 38b, include hooks 64a and 64b, respectively, which tie into a pulley and cable system 66. Cable 68a is connected to hook 64a and passes through pulleys 70b and 92b and is attached to lever 74. Similarly, cable 68b is attached to hook 64b and passes through pulley 70a and 92a and is likewise attached to lever 74. Lever 74 has one end attached to lever mount bar 78 about which it can freely rotate. A lever ratchet/guide mechanism 76 allows the lever 74 to be pulled backward and set in one of the teeth of the guide so it stays locked in that position. The jaws 38a and 38b include a bracket post 48a and 48b, respectively that selectively engage the vertical rim support bracket posts 52a and 52b of rim support brackets 50a and 50b, respectively. Rim support brackets 50a and 50b also include a horizontal rim engaging or support section 54a and 54b which are intended to engage the underside of the rim of a pot 12.

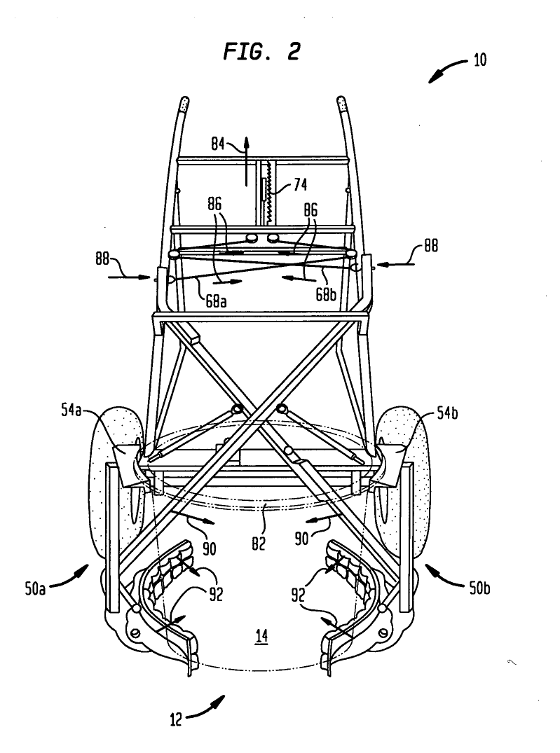

FIG. 2 illustrates the invention 10 when it is in the jaws closed or pot gripping mode. In order to grip a pot 12, the lever 74 is pulled backwardly in the direction of arrow 84. This in turn pulls on cables 68a and 68b moving them in the direction of arrows 86 and causing the distal portions of arms 58a and 58b to move in the direction of arrows 88 towards each other. This, in turn, causes the lower portion of the arms 58 a and 58b to move in the direction of arrows 90 towards each other which, in turn, causes the right and left jaws 38a and 38b to move in the direction of arrows 92 as they grab the tapered sidewalls 14 of the pot 12. Simultaneously the horizontal rim support members 54a and 54b engage the underside of the rim 82 of the pot 12 thereby further stabilizing the pot 12 and preventing it from tipping over. At this point the user can push down on the handles and move the pot 12 to another location. After the user does so, he or she lets the pot 12 down on the ground and releases lever 74, where upon arrows 84, 86, 88, 90 and 92 reverse each other and the pot 12 is thereby released.

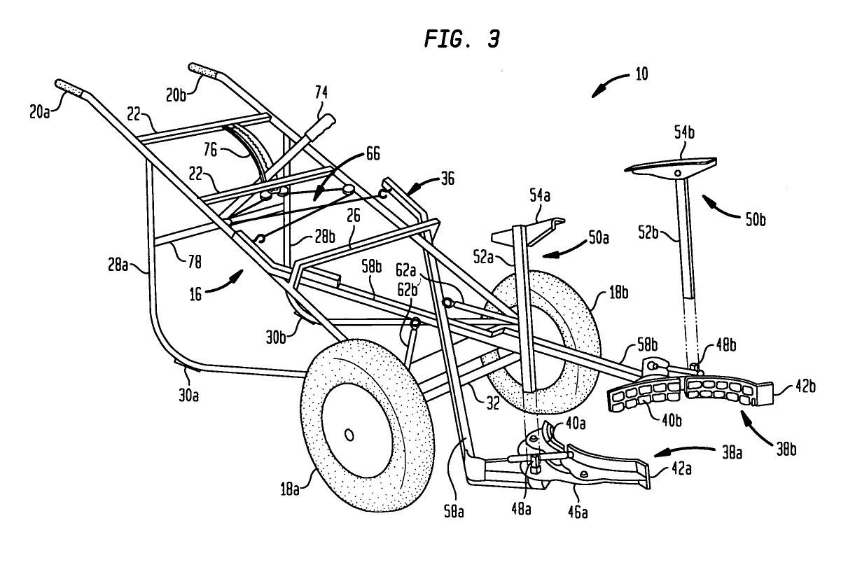

FIG. 3 is a perspective front view of the hand cart 10 showing the removable pot rim support brackets 58a and 58b separated from their mounting posts 48a and 48b. This is the position that the cart 10 might be in prior to moving a pot.

FIG. 4 illustrates the cart 10 in the horizontal position with its weight being supported on skid plates 30a and 30b. This is the position that the cart 10 might be in when it is being stored.

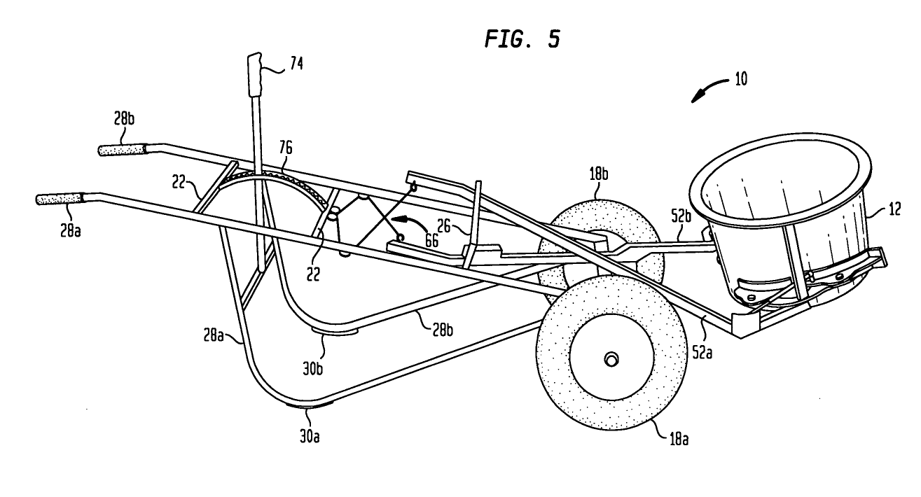

FIG. 5 is similar to FIG. 4 except that it shows the hand cart 10 in the horizontal position while it is still gripping a pot 12. This might be the position of the cart 10 just prior to transport.

A major of advantage of the hand cart 10 is that it enables one person to easily lift and move round, cylindrical or conical objects such as pot 12. The cart 10 helps the user, by himself or herself, grasp, lift and move containerized plants and balled or burlaped plants of multiple diameters. It is intended to help to (i) alleviate the possibility of fatigue and stress caused by repetitive chores involving the hands, arms and back, (ii) protect one's hands and arms from cuts and abrasions, (iii) make such chores more productive by making the labor less strenuous and intensive, and (iv) lessen the possibility of damage to the plants being moved.

In horticultural applications, the cart 10 can be used in nurseries and garden centers to move containerized or balled and burlaped plants, shrubs and trees, as well as large, heavy containers. It can lift these items both into and off from a 6″ high pallet. Standard prior art carts, presently in use, require the operator to lean the object being moved frontward in order to position the cart under the object. Then, the object being moved is leaned backwards often requiring a second person to help. This labor intensive process, however, is unnecessary if one uses the new cart 10 according to the present invention. The new hand cart 10 picks up items in a nearly vertical direction, thereby lessening the chances of damaging the plants and spilling the contents.

The cart 10, according to the preferred embodiment, is capable of lifting and moving round containers and other similar objects of up to (i) 150 pounds, (ii) a twenty (20) gallon plant pot, (iii) a diameter of not less than 12″ or more than 20″. A maximum diameter of 20″ is a bit misleading, however, since potted and balled plants are wider at the top than at the bottom. Therefore, the cart 10 is capable of lifting a containerized or a balled or burlaped plant having at least a 24″ diameter at the top.

A medium to large sized plant, either potted or burlaped, is heavy and awkward for anyone to move, since it seldom has handles, and usually requires two people to move. Many plants with a wide-branching habit are even more difficult to move without causing damage to a person's eyes, or other body parts, or to the plant being moved. The cart 10, according to the preferred embodiment, functions well not only for operation by one person, but also for those people who have lesser body strength.

The jaws 38a and 38b, which grip the object 12, being picked up and moved are padded with rubber 44 to decrease the changes of slippage and abrasion. The handles 20a and 20b are covered with soft rubber grips for comfort and to improve grippage.

The cart 10 is light, strong and easily maneuvered. Its total width is about 33″, enabling it to pass through narrow openings such as gates and paths. The gas springs 56a and 56b hold the jaws 38a and 38b in an open position in normal use. In order to use the cart 10, the user simply raises the cart's handles 20a and 20b, positions the gripping jaws 38a and 38b around the object 12, and pulls back and locks the clamping mechanism lever 74, which squeezes the jaws 38a and 38b snuggly around the object 12. By lowering the cart's handles 20a and 20b, the object 12 is raised off the surface or ground is ready to be moved. This takes only a few seconds to accomplish. Upon moving the object to a new desired location, one lowers and releases the plant or container 12 into its new spot by raising the handles 20a and 20b and releasing the gripper jaws 38a and 38b by moving the lever 74 forward. When moving certain large plastic containers 12, it may be necessary to install the optional rim support brackets 50a and 50b, which are stored on the cart 10 when not needed.

While the invention has been described reference to the preferred embodiment thereof, it will be appreciated by those of ordinary skill in the art that various modifications can be made to the various parts of the invention without departing from the spirit and scope of the invention as a whole.

1. A hand cart apparatus for transporting a vessel having cylindrical or tapered sidewalls and a rim, said apparatus comprising:
a pair of wheels;
a frame supported by said wheels;
a first arm pivotally attached to said frame, said first arm having a first and a second end;
a second arm also pivotally attached to said frame, said second arm having a first and second end and wherein said first and second arms cross each other;
a first jaw attached to the second end of said first arm;
a second jaw attached to the second end of said second arm;
driving means for driving said first ends of said first and second arms toward each other so that said jaws move toward each other,
wherein said driving means causes said first and second jaws to contact said sidewalls of said vessel and hold said vessel so that said vessel can be picked up and wheeled to another location.

2. The apparatus of claim 1 wherein said first and second jaw each include:
a jaw base plate;
a front jaw mounted on said base plate, and,
a rear jaw also mounted on said base plate.

3. The apparatus of claim 2 further comprising:
a gas spring located connected between said front jaw and said jaw base plate.

4. The apparatus of claim 3 further comprising:
a bracket support pin located on said jaw base plate; and
rim support bracket means selectively attachable to said bracket support pin for contacting and supporting the rim of said vessel.

5. The apparatus of claim 4 wherein said rim support bracket means comprises:
a vertical section for selectively engaging said bracket support pin; and,
a horizontal section attached to said vertical section for engaging said rim of said vessel.

6. The apparatus of claim 5 further comprising:
a pulley system mounted on said frame;
cable means connected so said pulley system and attached at one end to said first and second arms; and,
a lever means pivotally connect to said frame and also attached to said cable system,
wherein movement of said lever causes said cable means to move which also moves said first and second arms so that jaws move into and out of engagement with said vessel.

7. The apparatus of claim 6 further comprising:
spring means attached at one end to said frame and at the other end to said first and second arms for biasing said first and second jaws into a normally open position.

8. The apparatus of claim 7 further comprising:
a first and a second leg attached to said frame; and,
skid means attached to said first and second legs, wherein said apparatus rests on said skids when not in use.

9. The apparatus of claim 8 further comprising:
a ratchet guide mounted on said frame for guiding and holding said lever in position when said jaws are a gripping a vessel.
